(19) United States
(12) Patent Application Publication
(10) Pub. No.: US 2014/0050956 A1
(43) Pub. Date: Feb. 20, 2014

(54) SINGLE WINDING CORE, LITHIUM CELL WITH SINGLE WINDING CORE AND SUCCESSIVE WINDING METHOD FOR SINGLE WINDING CORE

(71) Applicant: DIJIYA ENERGY SAVING TECHNOLOGY INC., New Taipei City (TW)

(72) Inventor: Wen-Hung HUANG, New Taipei City (TW)

(73) Assignee: DIJIYA ENERGY SAVING TECHNOLOGY INC., New Taipei City (TW)

(21) Appl. No.: 13/828,653

(22) Filed: Mar. 14, 2013

(30) Foreign Application Priority Data
Aug. 15, 2012 (TW) 101129501

(51) Int. Cl. H01M 10/04

(52) U.S. Cl. CPC H01M 10/0431
USPC 429/94; 29/623.5

(57) ABSTRACT

Provided include a single winding core, a lithium cell with a single winding core, and a successive winding method of a single winding core, where a positive area on a surface of a positive plate corresponds to a negative area on a surface of a negative plate of the single winding core; a plurality of positive tabs and a plurality of negative tabs are respectively disposed at one side of the positive plate and the negative plate, and the negative tabs and the positive tabs are arranged to be interlaced with each other. Thereby, after the positive plate, a first isolation film, the negative plate, and a second isolation film are sequentially stacked and then successively wound, the positive tabs and negative tabs respectively form a positive and a negative tab groups, rendering the single winding core capable of high-current discharge.

### BACKGROUND OF THE INVENTION

1. Field of the Invention

The present invention relates to a single winding core, a lithium cell with a single winding core, and a successive winding method of a single winding core, and in particular to a single winding core having high-current discharge, and a lithium cell with a single winding core which is conveniently assembled when the single winding core is combined in a casing, and has improved conductive performance.

2. Related Art

At present, a winding core of a lithium cell mainly adopts two assembly manners, a lamination or winding. In the winding assembly manner, a negative plate is wrapped with a positive plate, so as to form a single winding core in which a negative tab at one end of the negative plate lies on an edge end of the winding core, and a positive tab of the positive plate lies in a center of the winding core. Because the positive tab lies in a central position of the single winding core, when the single winding core is placed in an aluminum casing, and the positive tab and the negative tab are respectively welded at bottom portions of a positive pole and a negative pole at an upper side of the aluminum casing, the welding operation is inconvenient, and moreover, usually, an internal resistance is increased and conductivity is worsened due to poor welding.

In addition, in the winding manner of the single winding core, a single positive tab is merely set on the positive plate and a single negative tab is merely set on the negative plate, which cannot achieve an effect of high-rate discharge. In order to overcome the foregoing disadvantages and make the single winding core have the capability of high-current discharge, at present, the practice of multiple winding cores is mostly adopted; however, due to a complex procedure, unstable uniformity is easily caused, resulting in problems such as a short circuit and air expansion.

Accordingly, in order to overcome the foregoing disadvantages, make the single winding core have the capability of high-current discharge, enable the lithium cell with a single winding core to be conveniently assembled when the single winding core is combined in the casing, and improve the conductive performance, the present invention is made by the inventors through years of experience, continuous development, research, and improvement.

### SUMMARY OF THE INVENTION

One object of the present invention is to provide a single winding core and a successive winding method of the single winding core, in which a plurality of spaced positive tabs is disposed at one side of a positive plate, a plurality of spaced negative tabs is disposed at one side of a negative plate, and after being stacked and wound, the negative tabs form a negative tab group and the positive tabs form a positive tab group respectively, thereby meeting large-volume and high-rate cell assembly requirements; moreover, mass production of the single winding core can be directly achieved in an automation manner, so as to effectively reduce a production cost.

Another object of the present invention is to provide a lithium cell with a single winding core, in which multiple positive tabs form a positive tab group, multiple negative tabs form a negative tab group, the positive tab group is welded at an inner wall of a casing, and the negative tab group is electrically connected to a negative wiring component, so as to improve operation efficiency, improve conductive performance, and reduce a short circuit risk to ensure safety in use.

In order to achieve the above objects, the single winding core provided by the present invention is formed through successive winding after stacking an elongated positive plate, a first isolation film, an elongated negative plate, and a second isolation film. The main technical features thereof lie in that, most of the area of a surface of the positive plate forms a positive area, a plurality of the spaced positive tabs is disposed at one side in a lengthwise direction of the positive plate; and most of the area of a surface of the negative plate forms a negative area, the negative area corresponds to the positive area, a plurality of spaced negative tabs is disposed at one side in a lengthwise direction of the negative plate. When the elongated positive plate is stacked with the elongated negative plate, the negative tabs and the positive tabs are interlaced with each other, so that after the successive winding of the positive plate, the first isolation film, the negative plate, and the second isolation film, the positive tabs form a positive tab group, and the negative tabs form a negative tab group.

The lithium cell with a single winding core provided by the present invention includes a casing, where an electrolyte fluid and the single winding core are placed in the casing, and a positive tab group and a negative tab group are formed at an upper side of the single winding core.

In implementation, the casing is a metal casing; a positive wiring component and a negative wiring component are disposed at a top surface of the metal casing; the positive tab group, the metal casing, and the positive wiring component are electrically connected to each other; and the negative tab group is electrically connected to the negative wiring component.

In implementation, a top end of the positive tab group is welded on an inner wall of the metal casing, where the casing includes a lower casing and a cover plate, and the positive wiring component and the negative wiring component are respectively connected to an upper side of the cover plate. An insulation sheet with a positioning hole is disposed at the upper side of the single winding core, the negative tab group is welded on a negative connection sheet, and the negative connection sheet threads upward through the positioning hole.

The successive winding method of a single winding core provided by the present invention comprises following steps: a. coating most of the area of a surface of a positive plate to form a positive area, and cutting one side of the positive plate in a lengthwise direction into a plurality of spaced positive tabs; b. coating most of the area of a surface of a negative plate to form a negative area, so that the negative area corresponds to the positive area, and cutting one side of the negative plate in a lengthwise direction into a plurality of spaced negative tabs; and c. stacking the elongated positive plate, a first isolation film, the elongated negative plate, and a second isolation film, so that the negative tabs and the positive tabs are interlaced with each other, and then successively winding the stacked elongated positive plate, the first isolation film, the elongated negative plate, and the second isolation film, so that the positive tabs form a positive tab group, and the negative tabs form a negative tab group.

In implementation, above method of the present invention further comprises following step: cutting two sides of the positive plate in a lengthwise direction into a plurality of spaced positive tabs, and cutting a middle of the positive area so as to split the positive plate into two pieces with the same shape and size.

In implementation, the method of the present invention further comprises following step: cutting two sides of the negative plate in a lengthwise direction into a plurality of spaced negative tabs, and cutting a middle of the negative area so as to split the negative plate into two pieces with the same shape and size.

The present invention will become more fully understood from the detailed description given herein below for illustration only.

### BRIEF DESCRIPTION OF THE DRAWINGS

FIG. 1 is an exploded view showing elements of a single winding core according to the present invention.

FIG. 2 is a perspective view showing the single winding core before being wound according to the present invention.

FIG. 3 is a perspective view showing the single winding core when being wound according to the present invention.

FIG. 4 is a perspective view showing the single winding core after being wound according to the present invention.

FIG. 5 is a perspective view in which positive tabs of a positive tab group and negative tabs of a negative tab group of the single winding core are respectively arranged in a progressive manner according to the present invention.

FIG. 6 is a perspective view in which a positive tab group and a negative tab group of the single winding core are respectively formed at two sides of an upper end of the single winding core according to the present invention.

FIG. 7 is a perspective view showing a first embodiment of a lithium cell with a single winding core according to the present invention.

FIG. 8 is a perspective view in which the single winding core of a second embodiment of an lithium cell with a single winding core is placed in a lower casing, and a positive tab is combined at an inner wall of the lower casing according to the present invention.

FIG. 9 is a perspective view in which an insulation sheet is placed at an upper side of the single winding core of the second embodiment of the lithium cell with the single winding core, and a negative connection sheet threading through a positioning hole of the insulation sheet is welded at a bottom of a negative wiring component according to the present invention.

FIG. 10 is a perspective view in which an insulation gummed paper is wrapped at the bottoms of the negative connection sheet and the negative wiring component of the second embodiment of the lithium cell with the single winding core according to the present invention.

FIG. 11 is a perspective view showing the second embodiment of the lithium cell with the single winding core according to the present invention.

FIG. 12 is a front view before a positive plate is cut according to the present invention.

FIG. 13 is a front view before a negative plate is cut according to the present invention.

### DETAILED DESCRIPTION OF THE INVENTION

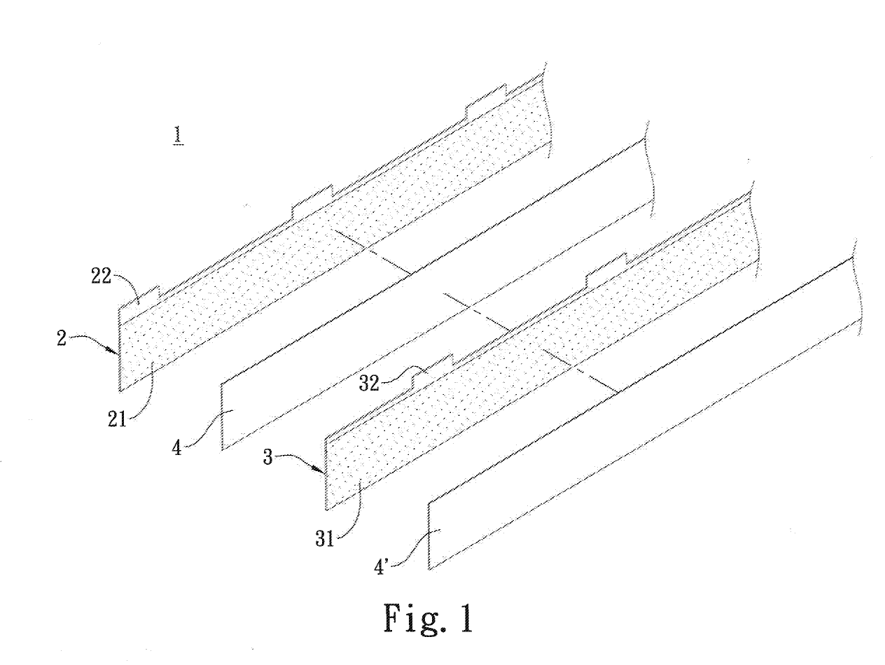

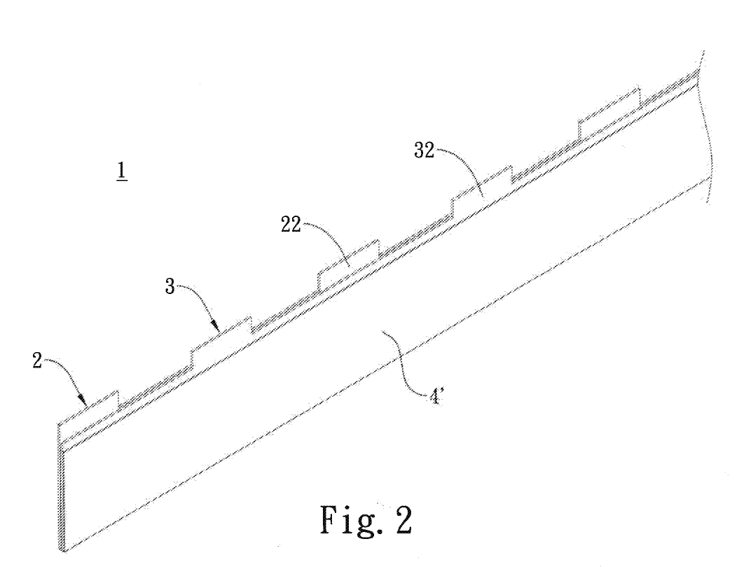

FIG. 1 and FIG. 2 show an exemplary embodiment of a single winding core 1 according to the present invention. The single winding core 1 includes an elongated positive plate 2, an elongated negative plate 3, a first isolation film 4, and a second isolation film 4′.

The positive plate 2 is preferably made by aluminum, and a positive area 21 is formed at most of the lower end area on a front and a back surfaces of the positive plate 2, where a layer of positive slurry with mixed positive material, a conductive agent, adhesive, and solvent is coated on a surface of the positive plate 2, and the positive area 21 is formed after performing a drying and rolling procedure on the positive slurry. A plurality of evenly spaced positive tabs 22 along a lengthwise direction is disposed at one side in the lengthwise direction of the positive plate 2, namely, at an upper end area of the positive plate 2.

The negative plate 3 is preferably made by copper, a negative area 31 is formed at most of a lower end area on a front and a back surfaces of the negative plate 3, where the negative area 31 corresponds to the positive area 21 of the positive plate 2. A layer of negative slurry with mixed positive material, a conductive agent, adhesive, and solvent is coated on a surface of the negative plate 3, and the negative area 31 is formed after performing a drying and rolling procedure on the negative slurry. A plurality of spaced negative tabs 32 are disposed at one side of the negative plate 3 in a lengthwise direction, and when the positive plate 2 is stacked with the negative plate 3, positions of the negative tabs 32 and positions of the positive tabs 22 are interlaced with each other.

The first and the second isolation films (4, 4′) are made of an insulation material, which may be polyethylene (PE), polypropylene (PP), or a multi-layer structure of the foregoing materials such as PE/PP/PE. The first isolation film 4 is sandwiched between the positive area 21 of the positive plate 2 and the negative area 31 of the negative plate 3, and the second isolation film 4′ is placed at one side of the negative area 31 of the negative plate 3.

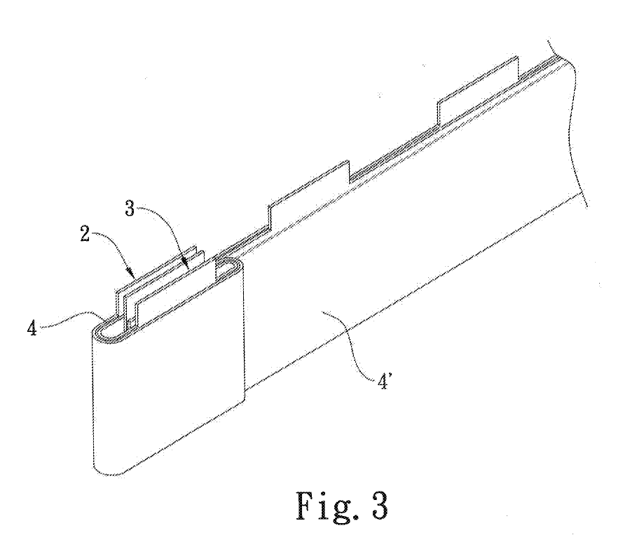

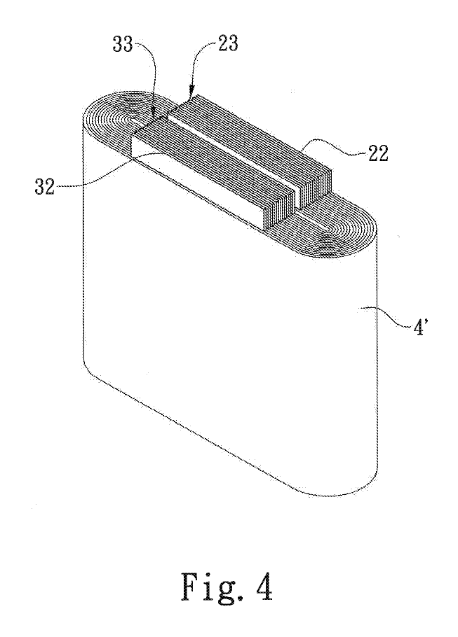

Therefore, as shown in FIG. 3, when the positive plate 2, the first isolation film 4, the negative plate 3, and the second isolation film 4′ are successively wound at the same time, the first and the second isolation films (4, 4′) may be respectively sandwiched between the positive area 21 of the positive plate 2 and the negative area 31 of the negative plate 3. As shown in FIG. 4, the positive tabs 22 form a positive tab group 23, and the negative tabs 32 form a negative tab group 33.

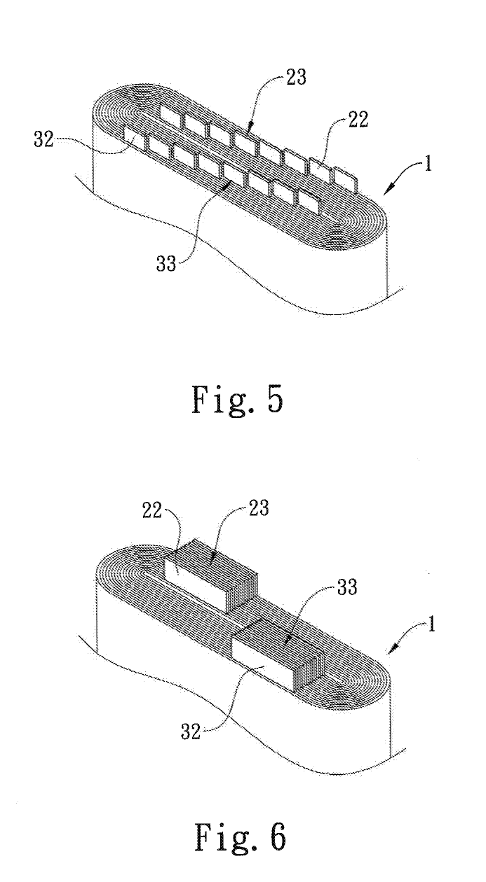

As shown in FIG. 5 and FIG. 6, by adjusting the space between the positive tabs 22 and the space between the negative tabs 32, the positive tabs 22 of the positive tab group 23 and the negative tabs 32 of the negative tab group 33 may be arranged in a progressive manner respectively, or the positive tab group 23 and the negative tab group 33 are formed at two sides of an upper end of the single winding core 1 respectively.

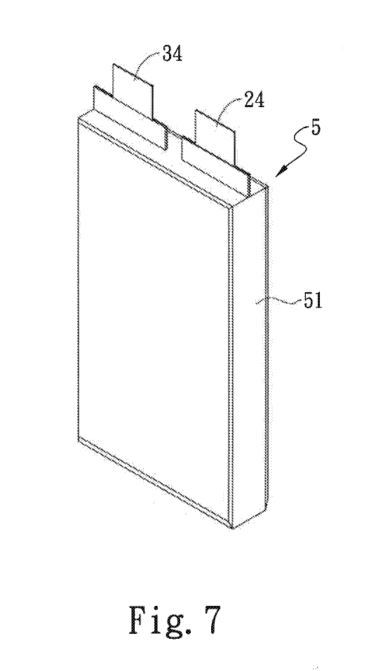

FIG. 7 shows a first embodiment of a lithium cell 5 with a single winding core according to the present invention. The lithium cell 5 includes a soft-package casing 51, where an electrolyte fluid and the foregoing single winding core 1 are placed in the casing 51. A positive tab group 23 formed at an upper side of the single winding core I is connected to a positive connection sheet 24, and a negative tab group 33 is connected to a negative connection sheet 34. After the casing 51 is closed, the positive connection sheet 24 and the negative connection sheet 34 respectively expose out of the casing 51.

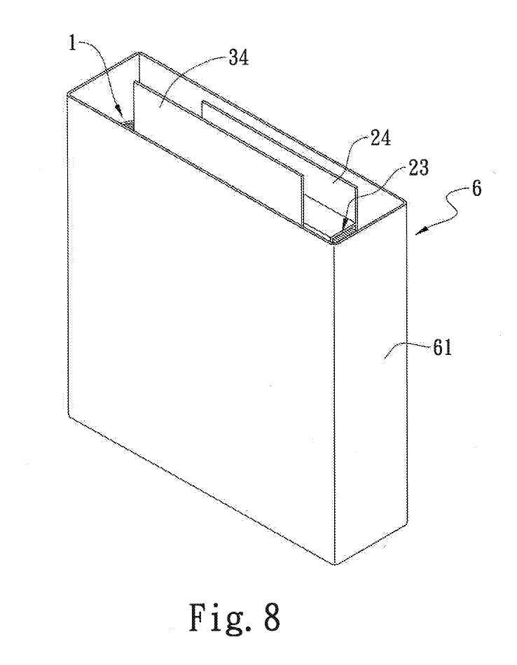

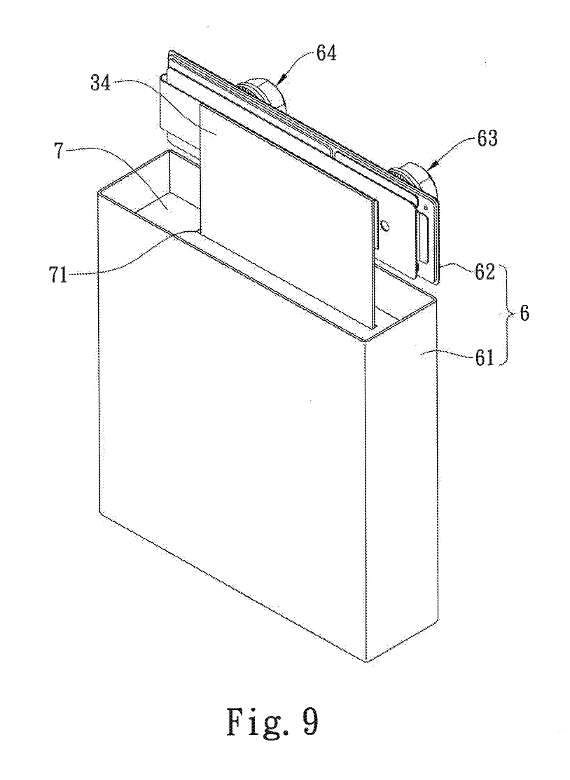

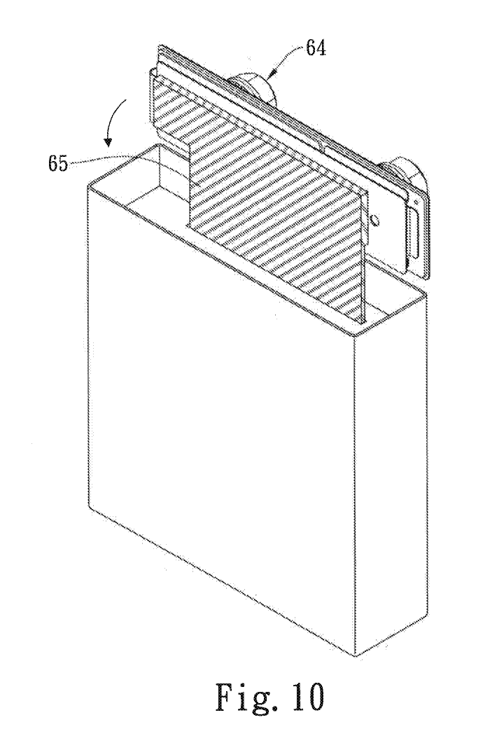

FIG. 8 and FIG. 9 show a second embodiment of the lithium cell 5 with a single winding core according to the present invention. The difference between the second embodiment and the first embodiment is as follows: this embodiment includes an aluminum casing 6, where the aluminum casing 6 includes a lower casing 61 with an opening on a top end thereof, and a cover plate 62 covering the top end of the lower casing 61 to close the opening; a positive wiring component 63 and a negative wiring component 64 are disposed at an upper side of the cover plate 62, and the positive tab group 23 is welded at an inner wall of the lower casing 61 through a positive connection sheet 24, so that the positive tab group 23, the casing 6, and the positive wiring component 63 are electrically connected to each other; an insulation sheet 7 with a positioning hole 71 is disposed at the upper side of the single winding core 1, the negative tab group 33 is welded on the negative connection sheet 34, and after threading upward through the positioning hole 71, the negative connection sheet 34 is welded at a bottom of the negative wiring component 64, so that the negative tab group 33 is electrically connected to the negative wiring component 64. As shown in FIG. 10, when a layer of an insulation gummed paper 65 is wrapped at the bottom of the negative connection sheet 34 and the negative wiring component 64, a short circuit may be prevented.

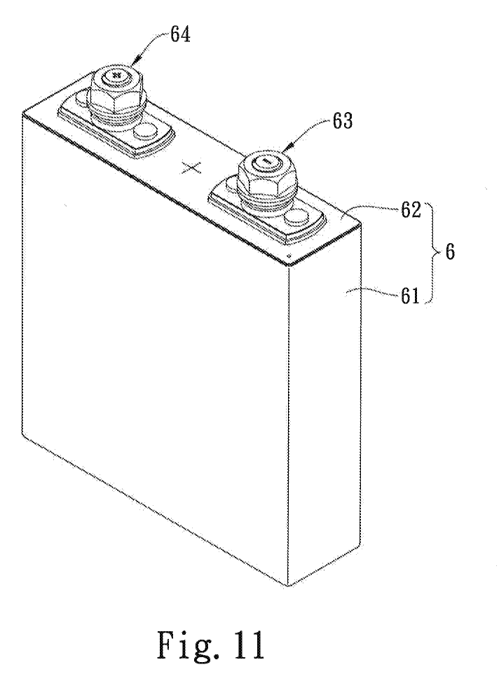

In this way, referring to FIG. 11, when the cover plate 62 covers the top end of the lower casing 61, the opening is sealed through spot welding, and the electrolyte fluid is filled into the casing 6, so that when the single winding core 1 operates, positive electricity and negative electricity may be output respectively through the positive wiring component 63 and the negative wiring component 64.

Referring to FIG. 1 to FIG. 4 at the same time, a successive winding method of a single winding core according to the present invention includes the following steps:

a. coating most of the area of the surface of the positive plate 2 to form a positive area 21, and cutting one side of the positive plate 2 in a lengthwise direction into a plurality of spaced positive tabs 22;

b. coating most of the area of the surface of the negative plate 3 to form a negative area 31, so that the negative area 31 corresponds to the positive area 21, and cutting one side of the negative plate 3 in a lengthwise direction into a plurality of spaced negative tabs 32; and
c. stacking the elongated positive plate 2, the first isolation film 4, the elongated negative plate 3, and the second isolation film 4′, so that the positive tabs 22 and the negative tabs 32 are interlaced with each other, and then successively winding the stacked elongated positive plate 2, the first isolation film 4, the elongated negative plate 3, and the second isolation film 4′, so that the positive tabs 22 form a positive tab group 23, and the negative tabs 32 form a negative tab group 33.

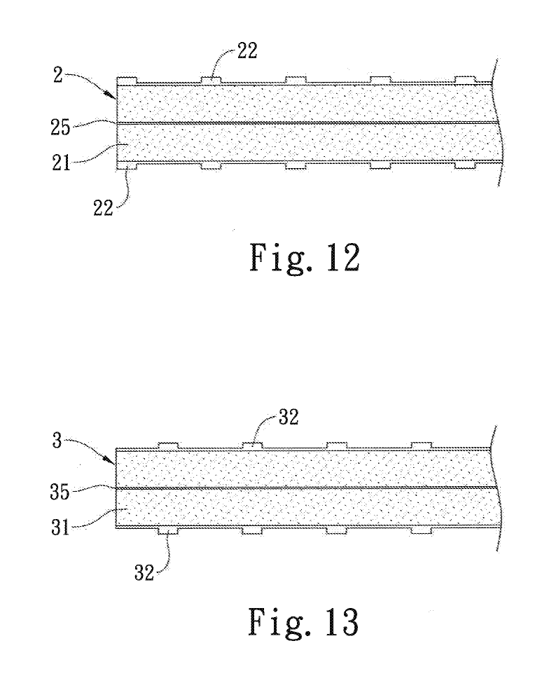

As shown in FIG. 12, when the step a is performed, the following step is further included: after the coating most of the area on the surface of the positive plate 2 to form a positive area 21, cutting two sides of the positive plate 2 in a lengthwise direction into a plurality of spaced positive tabs 22, and cutting along a middle line 25 the positive area 21 so as to split the one-piece positive plate 2 into two pieces with the same shape and size.

As shown in FIG. 13, when the step b is performed, the following step is further included: after coating most of the area on the surface of the negative plate 3 to firm a negative area 31, cutting both sides of the negative plate 3 in a lengthwise direction into a plurality of the spaced negative tabs 32, and cutting along a middle line 35 the negative area 31 so as to split the one-piece negative plate 3 into two pieces with the same shape and size.

Therefore, the present invention has the following advantages:

1. In the present invention, a positive tab group and a negative tab group may be formed on a single winding core at the same time; therefore, the large-volume and high-rate cell assembly requirements may be met, and mass production of the single winding core can be directly achieved in an automation manner, so as to effectively reduce a production cost.

2. In the present invention, after the single winding core is placed in a metal casing, a positive tab group is welded on the inner wall of the casing, and the negative tab group is electrically connected to the negative wiring component; therefore, the operation efficiency and the conductive performance can be improved, and moreover, a short circuit risk can be reduced to ensure safety in use.

3. In the present invention, length and width of the single winding core could be adjusted according to the size of different aluminum casings; therefore, the single winding core can be applied in various lithium cells of different size and specifications, and of different models.

To sum up, according to the aforementioned disclosure, the present invention can surely achieve the expected objectives to provide a single winding core with a capability of high-current discharge, a successive winding method of a single winding core, and a lithium cell with a single winding core that can be conveniently assembled when the single winding core is combined in the casing and has improved conductive performance. It is new and can be put into industrial use.

What is claimed is:

1. A single winding core, formed through successive winding after stacking an elongated positive plate, a first isolation film, an elongated negative plate, and a second isolation film, wherein
a positive area is formed at most of the area of a surface of the positive plate, and a plurality of spaced positive tabs are disposed at one side of the positive plate in a lengthwise direction; and
a negative area is formed at most of the area of a surface of the negative plate, the negative area corresponds to the positive area, a plurality of spaced negative tabs is disposed at one side of the negative plate in a lengthwise direction, and when the elongated positive plate is stacked with the elongated negative plate, the negative tabs and the positive tabs are interlaced with each other;
thereby, after the positive plate, the first isolation film, the negative plate, and the second isolation film are successively wound, the positive tabs form a positive tab group, and the negative tabs form a negative tab group.

2. A lithium cell with a single winding core according to claim 1, comprising a casing, wherein an electrolyte fluid and a single winding core are placed in the casing, and a positive tab group and a negative tab group are formed at an upper side of the single winding core.

3. The lithium cell according to claim 2, wherein the casing is a metal casing; a positive wiring component and a negative wiring component are disposed at a top surface of the metal casing; the positive tab group, the metal casing, and the positive wiring component are electrically connected to each other; and the negative tab group is electrically connected to the negative wiring component.

4. The lithium cell according to claim 3, wherein the casing comprises a lower casing with an opening on a top thereof and a cover plate covering the top end of the lower casing to close the opening, and the positive wiring component and the negative wiring component are respectively connected to an upper side of the cover plate.

5. The lithium cell according to claim 4, wherein an insulation sheet with a positioning hole is disposed at an upper side of the single winding core, and the negative tab group is welded on a negative connection sheet, and the negative connection sheet threads upward through the positioning hole.

6. The lithium cell according to claim 3, wherein a top end of the positive tab group is welded on an inner wall of the metal casing.

7. The lithium cell according to claim 6, wherein the casing comprises a lower casing with an opening on a top end thereof and a cover plate covering the top end of the lower casing to close the opening, and the positive wiring component and the negative wiring component are respectively connected to an upper side of the cover plate.

8. The lithium cell according to claim 7, wherein an insulation sheet with a positioning hole is disposed at an upper side of the single winding core, and the negative tab group is welded on a negative connection sheet, and the negative connection sheet threads upward through the positioning hole.

9. A successive winding method of a single winding core according to claim 1, comprising steps of:
a. coating most of the area of a surface of a positive plate to form a positive area, and cutting one side of the positive plate in a lengthwise direction into a plurality of spaced positive tabs;
b. coating most of the area of the surface of a negative plate to form a negative area, so that the negative area corresponds to the positive area, and cutting one side of the negative plate in a lengthwise direction into a plurality of spaced negative tabs; and
c. stacking the elongated positive plate, a first isolation film, the elongated negative plate, and a second isolation film, so as to have the negative tabs and the positive tabs interlaced with each other, and then successively winding the stacked elongated positive plate, the first isolation film, the elongated negative plate, and the second isolation film, so that the positive tabs form a positive tab group, and the negative tabs form a negative tab group.

10. The successive winding method of a single winding core according to claim 9, further comprising a step of: coating most of the area of the surface of the positive plate to form a positive area, cutting two sides of the positive plate in a lengthwise direction into a plurality of spaced positive tabs, and cutting a middle of the positive area so as to split the positive plate into two pieces with the same shape and size.

11. The successive winding method of the single winding core according to claim 9, further comprising: coating most of the area of the surface of the negative plate to form a negative area, cutting two sides of the negative plate in a lengthwise direction into a plurality of spaced negative tabs, and cutting a middle of the negative area so as to split the negative plate into two pieces with the same shape and size.
